(19) United States
(12) Patent Application Publication
(10) Pub. No.: US 2005/0274395 A1
(43) Pub. Date: Dec. 15, 2005

(54) Microarray wash tray

(75) Inventor: Douwe D. Haga, Redwood City, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 10/868,406

(22) Filed: Jun. 14, 2004

(51) Int. Cl. B08B 9/20; B08B 3/04

(52) U.S. Cl. 134/25.1; 134/104.2

(57) ABSTRACT

The present teachings relate to devices and methods for washing microarray slides.

### FIELD

The present application relates to systems, devices and methods for of washing biological samples.

### INTRODUCTION

In the biological field, reactions on a solid surface can be used for hybridization assays. A known member of a binding pair on the solid surface can hybridize with a target member of the binding pair from the biological sample to form a duplex in the hybridization fluid. A pattern of duplexed binding pairs on the solid surface provides information about the biological sample. The pattern on the solid surface can be detected to map the information relative to the known members of the binding pairs on the solid surface. This is referred to as a microarray, which can be positioned on a slide. In certain instances, during the processing of microarray slides, it is desirable to provide a wash tray for contacting microarray slides with washing fluid, where bulk solution can be washed over two or more microarray slides simultaneously and/or specific solutions can be washed over individual microarray slides, and the washing fluid can be removed while keeping the microarray slides secured in place.

### SUMMARY

In various embodiments, the present teachings provide a wash tray for microarray processing including a tray opening and a tray bottom, wherein the tray bottom includes at least two recesses, each recess adapted to house one microarray slide with the microarray facing the tray opening, and a plurality of protrusions adapted to secure the microarray slides in place.

In various embodiments, the present teachings provide a wash tray for microarray processing including a tray opening and a tray bottom, wherein the tray bottom includes at least two recesses, each recess adapted to house one microarray slide with the microarray facing the tray opening, and a form-fitting cover adapted to provide even distribution of fluid to the recesses and to secure the microarray slides in place, the cover including a passage for removing the fluid.

In various embodiments, the present teachings provide a method for washing microarray slides including positioning at least two microarray slides in at least two recesses of a wash tray, securing the microarray slides in place, so that each microarray slide faces an opening in the wash tray, adding washing fluid to the wash tray, and removing the washing fluid from the wash tray by tilting the wash tray to pour out the washing fluid, such that tilting does not release the microarray slides.

In various embodiments, the present teachings provide a wash tray for processing microarray slides including means for containing the washing fluid and means for securing the microarray slide in place.

### BRIEF DESCRIPTION OF THE DRAWINGS

FIG. 1 illustrates a perspective top-view of a wash tray according to various embodiments of the present teachings;

FIG. 2 illustrates a perspective top-view of microarray slides positioned in the wash tray illustrated in FIG. 1;

FIG. 3 illustrates a perspective bottom-view of the wash tray illustrated in FIG. 1;

FIG. 4 illustrates a perspective top-view of several wash trays stacked while holding microarray slides according to various embodiments of the present teachings;

FIG. 5 illustrates a perspective top-view of a wash tray on an orbital agitator according to various embodiments of the present teachings; and

FIG. 6 illustrates a flow-chart of a process for treating the microarray slide which can include a wash tray according to various embodiments of the present teachings.

### DESCRIPTION OF VARIOUS EMBODIMENTS

In this application, the use of the singular includes the plural unless specifically stated otherwise. In this application, the use of “or” means “and/or” unless stated otherwise. Furthermore, the use of the term “including”, as well as other forms, such as “includes” and “included”, is not limiting. Also, terms such as “element” or “component” encompass both elements and components comprising one unit and elements and components that comprise more than one subunit unless specifically stated otherwise. Wherever possible, the same reference numbers will be used throughout the drawings to refer to the same or like parts.

The section headings used herein are for organizational purposes only, and are not to be construed as limiting the subject matter described. All documents cited in this application, including, but not limited to patents, patent applications, articles, books, and treatises, are expressly incorporated by reference in their entirety for any purpose.

The term “wash” and “washing” as used herein refers to contacting a microarray with liquid. The term “wash tray” refers to a container for contacting a microarray with liquid. The term “washing fluid” as used herein refers to the liquid contacted with the microarray. The washing fluid can include bulk solution or specific solution. The term “bulk solution” as used herein refers to liquid intended to contact each microarray slide in the wash tray. The term “specific solution” as used herein refers to liquid intended to contact an individual slide in the wash tray. Certain steps in microarray processing can require individual treatment of certain microarray slides or the same treatment for each microarray slide.

In various embodiments, the microarray can be processed to emit fluorescent light and/or chemiluminescent light. Microarrays can have densities of 4 binding sites or features per square millimeter or up to 10⁴ binding sites or features per square millimeter. Binding sites can be positioned on the substrate by pin spotting, ink-jetting, photo-lithography, and other methods known in the art of high density deposition.

In various embodiments, the slide can be constructed of any material including, but not limited to, metals, glass, plastic, and/or composite material that is compatible with the microarray or any substrate onto which the microarray is deposited. The slides can have any cross-sectional shape including, but not limited to, circular, triangular, rectangular, etc. In various embodiments, the slide can be coated with a substrate onto which the microarray is deposited. Different substrates are known in the art and include non-porous and porous materials such as nylon.

In various embodiments, the wash tray can be constructed of any material including, but not limited to, metals, glass, plastic, and/or composite material that is compatible with the washing fluid. The wash tray can be constructed of different materials such that the protrusions are constructed of one material and the walls can be constructed of a different material. Similarly, the cover can be constructed of a different material than the rest of the wash tray. In various embodiments, the wash tray and/or portions of it can be constructed of materials known in the art such as elastomeric material such as Silicone Rubber, FDA approved Silicone Rubber, EPDM Rubber, Neoprame (CR) Rubber, SBR Rubber, Nitrile (NBR) Rubber, Butyl Rubber, Hypalon (CSM) Rubber, Polyurethane (PU) Rubber, Viton Rubber, and polydimethylsiloxane (Slygard™ elastomer by Dow Corning), or harder plastics such as acrylonitrile-butadiene-styrene plastic, polyurethane, polyvinylchloride, polycarbonate, polyethylene, TEFLON™, polystyrene, KALREZ™, or other materials known in the art of consumables manufacturing. In various embodiments, the wash-tray can have any cross-sectional shape including, but not limited to, circular, triangular, rectangular, etc.

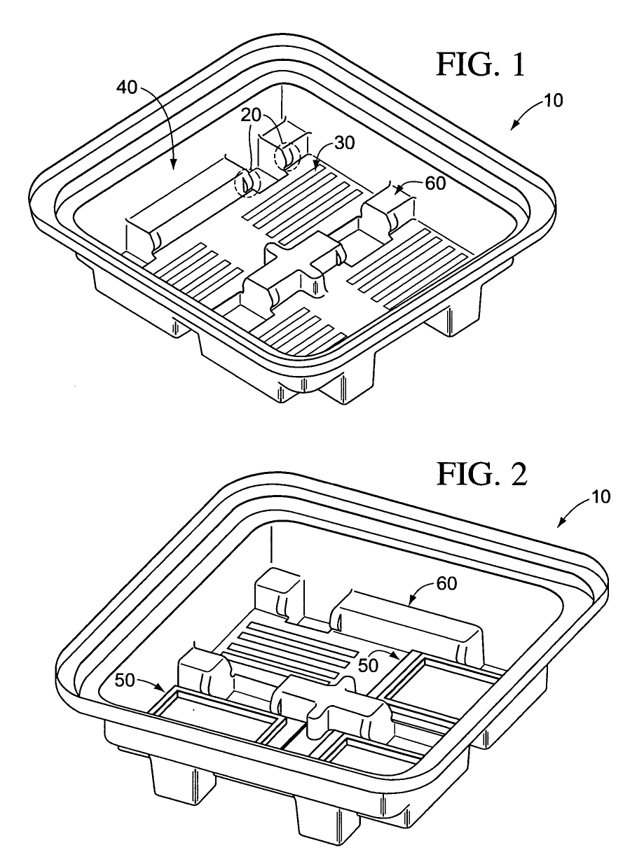

In various embodiments, as illustrated in FIG. 1, wash tray 10 can include a tray opening 60 and a tray bottom 40. The tray bottom 40 can include recesses 30 and protrusions 20. The tray bottom 40 and tray opening 60 form a bulk volume. FIG. 1 illustrates four recesses 30. In various embodiments, there can be any number of recesses that require more than two microarray slides to be processed together.

In various embodiments, the protrusions and the tray bottom can be releasably connected or inseparably connected, while providing means for securing the microarray slides in place. The protrusions can be permanent or retractable. In various embodiments, the slides can snapped in place by deforming the protrusions or retracting the protrusions. In various embodiments, the protrusions in the center of the tray can be softer and offer less resistance to securing and releasing the microarray slides. In various embodiments, the protrusions can be chamfered or rounded.

In various embodiments, the recesses can be isolated from each other to permit individual processing of microarray slides. The recesses can be blocked off from each other by extending the center of the tray (not shown) to the sides of the tray.

In various embodiments, as illustrated in FIG. 2, the wash tray 10 can house microarray slides 50 such that the microarrays face the tray opening 60 and are secured in place by the protrusions. In various embodiments, a cover (not shown) can be positioned over the microarray slides to secure them in place. The cover can be form-fitting such that it has the same contours as tray bottom. In various embodiments, the cover can include a cut-out or holes to permit the fluid to be poured out by tilting the wash tray. The cut-out can be a corner of the cover such that the remainder of the cover provides form-fitting to couple with the tray bottom.

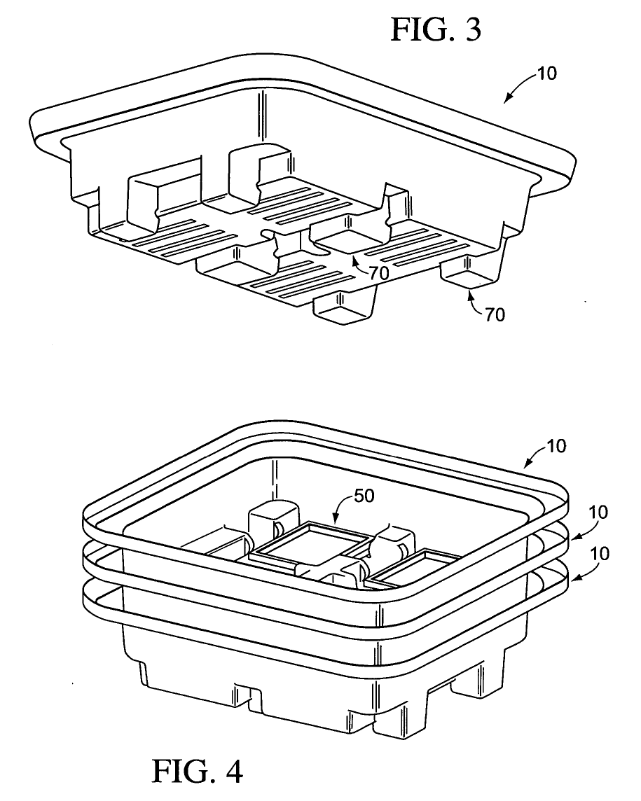

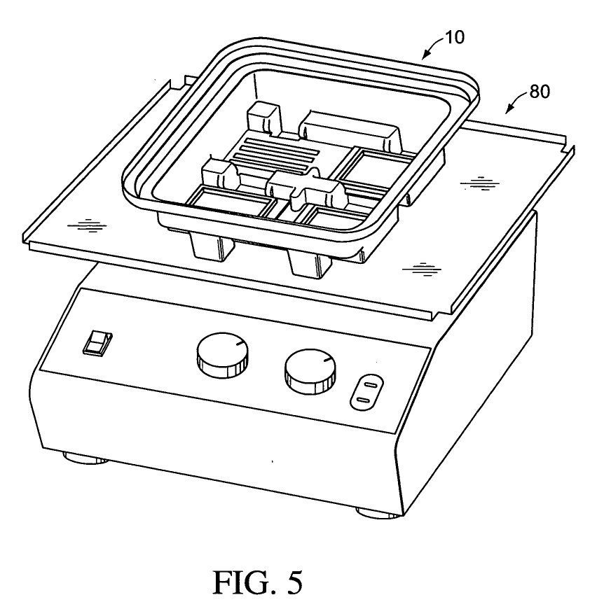

In various embodiments, as illustrated in FIG. 3, a wash tray 10 can include a base with spacers 70. The spacers 70 can be used to permit stacking of multiple wash trays 10 as illustrated in FIG. 4. In various embodiments, as illustrated in FIG. 5, wash tray 10 can be positioned on a rocker 80 for agitation of the wash fluid to provide thorough contacting of the microarray with the wash fluid.

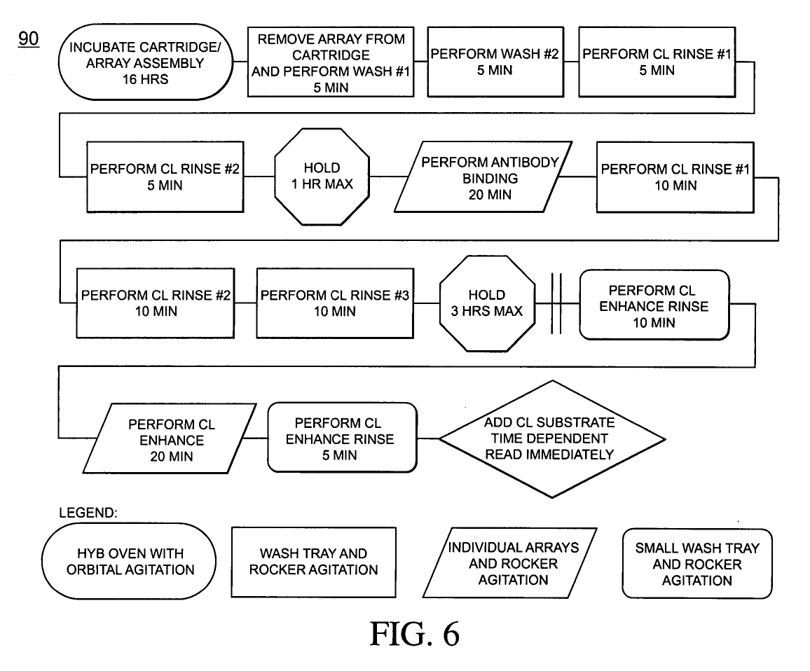

In various embodiments, as illustrated in FIG. 6, a microarray processing protocol 90 can include several washing steps that can be performed in a wash tray. In protocol 90, the wash tray can be used in all the steps up to the double vertical lines. The bulk solution steps are indicated by the rectangles in the flow chart. Although, the antibody step is performed on the individual microarrays, the microarray slides can remain in the wash tray. In various embodiments, the steps after the double vertical lines can be performed in a wash tray with recesses isolated from each other to conduct the steps as separable reactions, even though the recess volumes are a portion of the bulk volume. The specific solution steps are indicated by the rounded rectangles.

In various embodiments, the method for washing the microarray slides to perform a step in the protocol can include positioning at least two microarray slides in at least two recesses of a wash tray by securing the microarray slides in place with protrusions and/or cover. The microarray slides are positioned such that each microarray faces the opening in the wash tray. Either before positioning the microarray slides or after positioning them, the washing fluid can be added to the wash tray. In various embodiments, adding the washing fluid can include adding bulk solution or dispensing specific solution into the recesses. The specific solution is a measured volume such that it does overflow the recess volume into the bulk volume. The washing fluid can be removed from the wash tray by tilting the wash tray by pouring it out, such that tilting the wash tray to pour out the washing fluid does not release the microarray slides.

Other various embodiments of the invention will be apparent to those skilled in the art from consideration of the specification and practice of the invention disclosed herein.

1. A wash tray for microarray processing, the wash tray comprising:
a tray opening; and
a tray bottom, wherein the tray bottom comprises:
at least two recesses, wherein each recess is adapted to house one microarray slide with the microarray facing the tray opening; and
a plurality of protrusions adapted to secure the microarray slides in place.

2. The wash tray of claim 1, further comprising a tray base adapted for stacking the wash trays.

3. The wash tray of claim 2, wherein the tray base comprises spacers adapted to provide clearance between trays.

4. The wash tray of claim 1, wherein the wash tray provides a bulk volume for bulk access to each recess.

5. The wash tray of claim 4, wherein each recess provides a recess volume for separable reactions, wherein the recess volumes are a portion of the bulk volume.

6. The wash tray of claim 1, wherein the protrusions are rounded

7. The wash tray of claim 1, wherein the protrusions are chamfered.

8. The wash tray of claim 1, wherein the protrusions are retractable.

9. A wash tray for microarray processing, the wash tray comprising:
a tray opening;
a tray bottom, wherein the tray bottom comprises:
at least two recesses, wherein each recess is adapted to house one microarray slide with the microarray facing the tray opening; and
a form-fitting cover adapted to provide even distribution of fluid to the recesses and to secure the microarray slides in place, wherein the cover comprises a passage for removing the fluid.

10. The wash tray of claim 9, wherein the passage is a cut out portion of the cover.

11. The wash tray of claim 10, wherein the cut-out is a corner of the cover.

12. The wash tray of claim 9, wherein the passage is a plurality of holes in the cover.

13. A method for washing microarray slides, the method comprising:
positioning at least two microarray slides in at least two recesses of a wash tray;
securing the microarray slides in place, wherein each microarray slide faces an opening in the wash tray;
adding washing fluid to the wash tray; and
removing the washing fluid from the wash tray by tilting the wash tray to pour out the washing fluid, wherein tilting does not release the microarray slides.

14. The method of claim 13, wherein securing the microarray slides further comprises snapping the microarray slides in place with protrusions.

15. The method of claim 13, wherein securing the microarray slides further comprises positioning a form-fitting cover over the opening in the wash tray.

16. The method of claim 13, wherein adding washing fluid comprises adding a bulk solution to a bulk volume of the wash tray.

17. The method of claim 13, wherein adding washing fluid comprises dispensing at least one specific solution into at least one of the recesses.

18. The method of claim 13, further comprising binding antibodies to the microarrays.

19. A wash tray for processing microarray slides, the wash tray comprising:
means for containing the washing fluid; and
means for securing the microarray slide in place.

20. The wash tray of claim 19, wherein the means for containing the washing fluid comprises means for individually processing each microarray slide.
